(19) United States
(12) Patent Application Publication
(10) Pub. No.: US 2007/0232497 A1
(43) Pub. Date: Oct. 4, 2007

(54) Water soluble tape

(76) Inventors: Yiwen Chew, Singapore (SG); Yi Xin Chew, Singapore (SG)

Correspondence Address: LAWRENCE Y.D. HO & ASSOCIATES PTE LTD, 30 BIDEFORD ROAD, #02-02, THONGSIA BUILDING, SINGAPORE, 229922, SG

(21) Appl. No.: 11/396,606

(22) Filed: Apr. 4, 2006

(51) Int. Cl. A01N 25/10

(52) U.S. Cl. 504/360; 424/405; 504/361

(57) ABSTRACT

The present invention provides a water soluble tape for controlled release of at least one active ingredient, a water soluble adhesive tape for controlled release of at least one active ingredient, a method for manufacturing a water soluble tape for controlled release of at least one active ingredient, and a method for utilizing the condensate water for cleansing and disinfection purposes.

### FIELD OF THE INVENTION

The present invention relates to products and methods for sustained release of active ingredients in an aqueous environment and, more specifically, to a water soluble tape that contains at least one water soluble polymer embedded with at least one active ingredient, and methods for using the water soluble tape to treat objects with condensate water, and further to methods for making the water soluble tape.

### BACKGROUND OF THE INVENTION

Condensate water usually forms on the interfaces with differential temperatures. The condensate water may be formed on surfaces of different objects with diversified materials. One exemplary object with continuously formed condensate water is air cooling systems including air conditioning devices and refrigeration devices. The air conditioning devices include fan-coil units, ceiling units, package units, ducted units, air handling units, and roof top units. The refrigeration devices include vending machines, ice-maker, beverage and grocery display cases, cold room, and walk-in cold storage.

A typical air conditioning device comprises a compressor, a condenser, an expansion device, a cooling coil and an air mover (blower). When the air conditioning device is in operation, condensate water will be continuously formed on the cooling coil. Usually, the condensate water from the cooling coil will be collected with a draining pan underneath of the cooling coil and disposed in different ways such as dumping to ground and conducting to the sewer system.

It is well known that the condensate water may contain a multitude of airborne germs (e.g., bacteria, mold spores, algae) that have adverse implications for humans. In addition, the condensate water may contain impurities from the air including dust, microparticles, and organic and/or inorganic chemicals. The impurities can cause corrosion of the surfaces of objects and stains due to scale deposition, and also reduce the cooling efficiency of the system. Furthermore, the growth of the airborne germs will make the condensate water foul and thus be detrimental to health and environment.

Most of air cooling systems have a drain pan that is located beneath their cooling coils to collect and drain condensate water from the cooling coils. Very often, when the drain pan is undisturbed and damp, it becomes a conducive environment for growth of microorganisms such as bacteria, viruses, algae, mold and mildew. When this happens, the waste product of the bacteria, mold, algae and dust will form the slime that will choke up the drainpipes extended from the drain pan, causing the condensate water to overflow from the drain pan. The overflow results in water leaking from the air conditioning unit, causing property damage. In severe conditions, foul odors can be emitted from the systems. The microorganisms can also enter into the air streams to cause diseases such as the Legionnaire's Disease, allergy reactions and other health associated problems such as headaches and fatigue, commonly known as the “sick building syndrome”. This problem is aggravated in old systems (2 years old or more), poorly maintained systems, or systems located in dirty or dusty environment. In addition, a dirty cooling coil due to dust, mold, slime, scale, and rust also results in reduced cooling efficiency, which in turn increases energy consumption.

Usually, a surface with condensate water needs to be frequently washed to prevent scale deposition, corrosion of metal surface, fouling, and growth of microorganisms. For example, the cleaning of the cooling coils may be accomplished by chemical spray, steam, or high-pressured water jet. The chemical spray has also been used as one way of disinfecting the cooling coils. However, all of the methods are inconvenient, time consuming, and expensive. And they do not offer a continuous cleaning or protection to the coils. In practice, scale deposition, corrosion of metal surface, fouling, and/or growth of microorganisms begin immediately after the cleaning process.

There are some attempts to address the problems of microorganisms entrapped within the condensate water. For example, U.S. Pat. No. 6,438,971 discloses a method of controlling an ultraviolet air treatment device including an ultraviolet lamp positioned to irradiate an air conditioner cooling coil. The UV from the ultraviolet lamp may be effective to kill the microorganisms entrapped within the condensate water to a certain extent. While the UV provides a long and continuous method of disinfection, this method, however, has apparent limitations including its limited effectiveness for killing microorganisms due to the aqueous environment shield afforded to the microorganisms, energy consuming, and no effects on scale deposition or corrosion, and more noticeably no cleaning functions.

### SUMMARY OF THE INVENTION

Therefore, one objective of the present invention is to provide products and methods that can be easily employed to continuously control the microorganisms entrapped within condensate water and at the same time to clean and prevent the scale deposition and corrosion on the surfaces with the condensate water. More importantly, the products and methods of the present invention utilize the condensate water itself to realize the purposes of controlling the microorganisms, and cleaning and preventing the scale deposition and corrosion.

In one embodiment of the present invention, there is provided a water soluble tape for controlled release of at least one active ingredient. In the embodiment, the water soluble tape comprises a water soluble polymer layer containing at least one water soluble polymer; and at least one active ingredient; whereby all the ingredients of the water soluble layer are thoroughly admixed and formed into the layer; and a water soluble adhesive layer laminated onto the water soluble polymer layer; wherein when the water soluble tape is applied via the adhesive layer to a surface of an object where condensate water will be formed, the condensation water will cause the at least one active ingredient to be released in a sustained manner. In another embodiment of the water soluble tape, the at least one water soluble polymer is in the range of 0.1-99.9% w/w; and wherein the at least one active ingredient is in the range of 0.1-99.9% w/w. In another embodiments of the water soluble tape, the water soluble polymer layer further optionally comprises a binder, a die release agent, a compression agent, a plasticizer, and a filler. In another embodiment, the water soluble tape further comprises a release layer disposed onto the adhesive layer; wherein the release layer will be removed before the water soluble tape is applied.

In another embodiment of the present invention, there is provided a water soluble adhesive tape for controlled release of at least one active ingredient. In the embodiment, the water soluble adhesive tape comprises at least one water soluble adhesive polymer; and at least one active ingredient; whereby all the ingredients of the water soluble adhesive tape are thoroughly admixed and formed into the tape; wherein when the water soluble adhesive tape is applied directly to a surface of an object where condensate water will be formed; and wherein the condensation water will cause the at least one active ingredient to be released in a sustained manner.

In another embodiment of the present invention, there is provided a method for manufacturing a water soluble tape for controlled release of at least one active ingredient, wherein the tape comprises a water soluble polymer layer having at least one water-soluble polymer and at least one active ingredient, and an adhesive layer. In the embodiment, the method comprises admixing thoroughly of all the components including the at least one water soluble polymer and the at least one active ingredient so as to form the water soluble polymer layer; and laminating the adhesive layer onto the water soluble polymer layer to form the water soluble tape.

In another embodiment of the present invention, there is provided a method for utilizing the water due to moisture condensation upon the surfaces of an object. In the embodiment, the method comprises applying a water soluble tape that will adhere to the surfaces of the object, wherein the water soluble tape contains at least one water soluble polymer and at least one active ingredient that is embedded within the at least one water soluble polymer and caused to be released by the condensed water of the cooling coils; thereby the at least one active ingredient released will cleanse and disinfect the surfaces of the object.

The objectives and advantages of the invention will become apparent from the following detailed description of preferred embodiments thereof in connection with the accompanying drawings.

### BRIEF DESCRIPTION OF THE DRAWINGS

Preferred embodiments according to the present invention will now be described with reference to the Figures, in which like reference numerals denote like elements.

FIG. 1 is a schematic diagram illustrating the water soluble tape in accordance with one embodiment of the present invention.

### DETAILED DESCRIPTION OF THE INVENTION

The present invention may be understood more readily by reference to the following detailed description of certain embodiments of the invention.

Throughout this application, where publications are referenced, the disclosures of these publications are hereby incorporated by reference, in their entireties, into this application in order to more fully describe the state of art to which this invention pertains.

The present invention provides products and methods for controlling the microorganisms entrapped within condensate water, preventing scale deposition and corrosion due to impurities within the condensate water, and cleansing the surface of coils of dust and grime from the air, wherein the condensate water is formed on surfaces of many systems and devices. While the products and application of the present invention will be described in specific configurations (e.g., tape) and specific applications (e.g., cooling coils of air conditioning systems), it is to be noted that the specific examples are by no means to limit the scope of the invention.

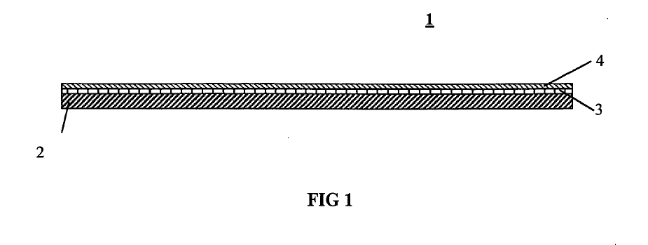

As defined herein, the “tape” refers to any configuration with a thin layer, sheet, or film. The tape may comprise one or more layers. As shown in FIG. 1, the tape 1 is configured to have two layers: an active polymer layer 2, and an adhesive layer 3. In addition, the tape has a release layer 4 that protects the adhesive layer before the tape is being used. The active polymer layer 2 comprises at least one water soluble polymer and at least one active ingredient. The adhesive layer 3 is disposed onto the active polymer layer so that the tape can be fixed onto the surfaces with or without condensate water (dry or wet surface). The adhesive layer is preferable made of water soluble adhesive materials. The release layer 4 could be any suitable material that protects the adhesive layer from being adhered before its application. It is to be noted that each layer may be laminated with two or more sub-layers.

The at least one water soluble polymer in the active polymer layer may be a regular water soluble polymer, an adhesive water soluble polymer, or a mixture of both types of polymers. It is to be noted that most of water soluble polymers do have some adhesive properties, then the distinction between a regular and adhesive water soluble polymer is pretty arbitrary. For the present invention, the adhesive water soluble polymers are the ones that they can render the tape to adhere to a dry surface of its application.

The exemplary water-soluble polymers include water-soluble poly(meth)acrylates, water-soluble polyamides, water-soluble polyesters, water-soluble polyurethanes, water-soluble poly(vinyl amine), water-soluble poly(ethylene imine), water-soluble amine/epihalohydrin polyamines, water-soluble poly(meth)acrylamide, water-soluble (meth)acrylamide copolymers, water-soluble poly(meth)acrylic acid, water-soluble copolymers of (meth)acrylic acid, poly(diallyl dimethyl ammonium halides), copolymers of diallyl dimethyl ammonium halides, water-soluble vinyl pyrrolidone, water-soluble copolymers of vinyl pyrrolidone, poly(meth)acrylamidopropyltrimethyl ammonium halides, copolymers of (meth)acrylamidopropyltrimethyl ammonium halides, poly(meth)acryloyloxyethyltrimethyl ammonium halides, copolymers of (meth)acryloyloxyethyltrimethyl ammonium halides, poly(meth)acryloyloxyethyltrimethyl ammonium methyl sulfate, copolymers of (meth)acryloyloxyethyltrimethyl ammonium methyl sulfate, xanthan gums, sodium alginates, galactomanans, carageenan, gum arabic, hydroxyethyl cellulose, hydroxypropyl cellulose, diallyl dimethyl ammonium chloride graft copolymers of hydroxyethylcellulose, polymeric quaternary ammonium salts of hydroxyethyl celluloses reacted with a trimethyl ammonium substituted epoxide, polymeric quaternary ammonium salts of hydroxyethyl celluloses reacted with lauryl dimethyl ammonium substituted epoxides, a quaternary ammonium derivative of hydroxypropyl guar and combinations thereof

In addition to the above listed water soluble cellulosic polymers, other natural and synthetic hydrophilic polymers such as gelatin, maltodextrin, xanthan gum and carrageenan, and synthetic hydrophilic polymers such as carboxymethyl guar, hydroxypropyl guar, carboxymethyl galactomannose, polyvinyl acetate and polyvinylpyrrolidone are also suitable for use in preparing the tapes of the present invention. It is also contemplated that mixtures of the above listed polymers can be so employed and such mixtures are within the scope of the present invention. It is to be appreciated that an adhesive water soluble polymer is added when the natural polymers do not have adhesive properties.

The active polymer layer also comprises at least one active ingredient. As defined herein, the “active ingredient” used in the present application refers to any chemical, material or substance that has at least one function desired by the user. The active ingredient shall not produce any chemical reactions within the tape so as to impair the desired function of the active ingredient or the release of the active ingredient when it is admixed with the at least one water-soluble polymer to form the tape. The exemplary active ingredients include pesticides, insecticides, toxicants, insect growth regulators, plant growth regulators, microbial control agents, bioactive control agents, parasites, bactericides, viricides, fungicides, algaecides, herbicides, nematicides, amoebicides, acaricides, miticides, predicides, schistisomicides, molluscicides, larvicides, pupicides, ovicides, adulticides, nymphicides, attractants, repellents, growth stimulants, feeding stimulants, nutrients, hormones, chemosterilants, or pheromones, fragrances, flavorants, food additives, surfactants and combinations thereof, such as the two, three or four component combinations. Two or more bioactive agents can be combined in the same composition to achieve multi functional performance from a single application.

General bioactive materials include Bacillus thuringiensis, and especially subspecies kurstaki and israelensis, Bacillus sphaericus, Bacillus popilliae, Seriatia marcescens, and Lagenidium giganteum. Fungal larvicides may also be employed such as Lagenidium giganteum mycelium or Lagenidium giganteum oospores or mixtures thereof. Fungal materials can also be effective against mosquito larvae. Waste treatment bacteria, grease degrading bacteria. Insect growth regulators can be used such as (S)-methoprene, diflubenzuron, or pyriproxyfen. Compositions and processes for control of various species of mosquitoes, and other pest dipterans in aquatic habitats are of particular interest. Other insecticides may also be employed including products such as malathion, resmethrin, dichlorvos, bendiocarb, fenitrothion or chlorpyrifos. Insecticides such as pyrethrin and pyrethroid can be effective as larvicides for mosquitoes. Various herbicides that may be employed, especially effective aquatic herbicides include Amitrole®, ammonium sulfamate, Bromacil®, copper salts, dalapon, Dichlorbenil®, Diquat®, Diuron®, Endothall®, Fenac®, Picloram®, Prometon®, Silvex®, Simazine®, trichloroacetic acid, 2,4-D, 2,4,5-T, Velpar®, TSMA, dicamba, endothall, silvex, prometon, chlorate, sodium metaborate, monuron, and various combinations thereof, such as the two, three or four component combinations.

Bioactive agents included in the compositions and processes for these applications include acrolein, aromatic solvents (xylene), copper sulfate and other water soluble copper salts or compounds, dalapon, dichlorbenil, 2,4-D, diquat, endothall, glyphosate, simazine, and fluridone, and combinations thereof, such as the two, three or four component combinations.

It should be noted that any bioactive agent (any inorganic chemicals or organic chemicals), and combinations thereof, such as the two, three or four component combinations, designed for promoting, enhancing (e.g., nutrients, flavorants, medicaments) or terminating (e.g., pesticides, or herbicides) the life of aquatic or terrestrial organisms can be utilized in the compositions of matter, depending on the desired end result.

The active ingredient also includes: (1) buffers to maintain the desired degree of acidity/alkalinity, e.g., a neutral or alkaline pH, including for example, alkali metal phosphates, borates and the like and mixtures thereof; (2) cavitation liner pitting inhibitors including alkali metal nitrites, molybdates and the like and mixtures thereof; (3) metal corrosion inhibitors and/or hot surface corrosion inhibitors including alkali metal nitrates and silicates, carboxylic acids, phosphonic acids, phosphonates, pyrophosphates, azoles, sulfonic acids, mercaptobenzothiazoles, metal dithiophosphates, metal dithiocarbonates, phenolic anti-oxidants including 4,4′″-methylenebis (2,6-di-tertbutylphenol that is commercially available under the trademark Ethyl 702 by Ethyl Corporation) and the like and mixtures thereof; and (4) hot surface deposition inhibitors and/or scale inhibitors including phosphate esters, phosphino carboxylic acids, polyacrylates, styrene-maleic anhydride copolymers, sulfonates and the like and mixtures thereof.

The active polymer layer may optionally comprise a binder. Suitable binder includes, for example, polyvinyl pyrrolidone, sodium acrylate, sodium polyacrylate, carboxymethylcellulose, sodium carboxyinethylcellulose, coren starch, microcrystalline cellulose, propylene glycol, ethylene glycol, sodium silicate, potassium silicate, methacrylate/acrylate copolymers, sodium lignosulfonate, sodium hydroxypropylcellulose.

The active polymer layer may optionally comprise at least one water soluble filler. The water soluble filler includes alkali metal bicarbonates, alkali metal sulfates, alkali metal carbonates, alkali metal citrates, alkali metal phosphates and sodium chloride. In addition, the inert, water-soluble fillers may also be used such as sodium sulphate, which are used to bulk up the extruded formulation. The filler may be a single salt or mixture of salts, which is preferably neutral, or only mildly acidic or alkaline, e.g., alkali metal carbonates, bicarbonates, sulphates, citrates and phosphates. The inert salts (filler salts) used in the compositions of the present invention can be any water-soluble inorganic or organic salt or mixtures of such salts. For purposes of the present invention, “water-soluble” means having a solubility in water of at least 2.0 grams per hundred grams of water at 20° C. Examples of suitable salts include various alkali metal and/or alkaline earth metal sulfates, chlorides, borates, bromides, citrates, acetates, lactates, etc. Specific examples of suitable salts include calcium sulfate, sodium chloride, potassium sulfate, sodium carbonate, lithium chloride, tripotassium phosphate, sodium borate, potassium bromide, potassium fluoride, sodium bicarbonate, calcium chloride, magnesium chloride, sodium citrate, sodium acetate, calcium lactate, magnesium sulfate and sodium fluoride. The preferred salts are the inorganic salts, especially the alkali metal sulfates and chlorides.

The active polymer layer may optionally comprise at least one plasticizer. The plasticizer includes lycerine, triethanolamine, ethylene glycol, propylene glycol, diethylene glycol, dipropylene glycol, diethanolamine and methyldiethylamine.

The active polymer layer may optionally comprise at least one surfactant. The surfactant includes sodium dodecylbenzenesulfonate and sodium toluenesulfonate, an anhydrous blend of Cocamide DEA and DEA-Myreth Sulfate detergent, solid anionic α.-sulfonate, solid anionic α.-sulfonate. Additional examples of surfactants having both detergent and foaming properties are alkyl benzene sulfonates, such as n-octyl benzene sulfonate (sodium salt), and sodium lauryl sulfate. The following surfactants are useful for their detergent properties, but cannot be depended upon for their foaming properties: a block copolymer of ethylene oxide and propylene oxide.

Nonionic surfactants that may be included are the condensation products of a long chain ethylene oxide moiety with an aliphatic alcohol preferably a primary or secondary aliphatic alcohol or alkyl phenol, preferably the primary or secondary alcohol contains 8 to 20 carbon atoms and the alkyl phenol-based moiety is one wherein the alkyl chain is straight or branched and contains 6 to 12 carbon atoms, preferably 6 to 9 carbon atoms. Illustrative nonionic surfactants having the desired characteristics for formulation are available on the market under the tradename of “Neodol” products by Shell Oil Company; “Tergitol” products by Union Carbide Company; and “Alfol” products by Continential Oil Company. Specific examples include “Neodol 25-7” (linear C₁₂ -C₁₅ primary alcohol condensed with 7 moles of ethylene oxide per mole of alcohol); “Neodol 45-7” (linear C₁₄-C₁₅ primary alcohol mixture condensed with 7 moles of ethylene oxide per mole of alcohol); “Tergitol 15-S7” (random secondary C₁₁-C₁₅ alcohol condensed with 7 moles of ethylene oxide per mole of alcohol); and “Alfol 1416-6.5” (.primary C₁₄-C₁₆ alcohol condensed with 6.5 moles of ethylene oxide per mole of alcohol). In addition, anionic surfactants have sulfate and/or sulfonate structure including alkyl benzenesulfonates, alkyl sulfates and olefin sulfonates. And fatty alcohol or alkylphenol ethoxylates can be used as nonionic surfactants.

The active polymer layer may optionally comprise a die release agent. Suitable die release agents include, for example, calcium stearate, magnesium stearate, zinc stearate, stearic acid, propylene glycol, ethylene glycol, polyethylene glycol, polypropylene glycol, polyoxypropylene-polyoxyethyleen block copolymers, microcrystalline cellulose, kaolin, attapulgite, magnesium carbonate, fumed silica, magnesium silicate, calcium silicate, silicones, mono- and dicarboxylic acids and core starch.

The active polymer layer may optionally comprise compression agents. The particular compression agent used is not critical and can be any suitable compression agent known in the art that is compatible with the other ingredients. Examples of suitable compression agents include dicalcium phosphate, lactose, sodium phosphate and calcium sulfate dihydrate.

In addition to the above-mentioned components, the compositions of the present invention may, optionally, contain other ingredients, for example, disinfecting or sanitizing agents, coloring agents, foam boosters, bleaching agents, preservatives, lime-scale removing agents, deodorizing agents, antioxidants, stabilizers, dispersants, stain-inhibiting agents, water-softening agents and/or Theological control agents. These may, for example, be added to the extruder containing the polymer during extrusion of the polymer, or may be separately mixed with the powdered polymer after the extrusion step. In this connection, it may be noted that the term “perfume” is intended to refer to any material giving an acceptable odor and thus materials giving a “disinfectant” odor such as essential oils, pine extracts, terpinolenes, ortho phenyl phenol or paradichlorobenzene may be employed

The size and dimension of the active polymer layer will vary over a wide range depending upon the particular application.

The active polymer layer may be manufactured by any known methods. In one embodiment of the present invention, at least water-soluble polymer and at least one active ingredient are admixed and made into the active polymer layer. The means and equipments for admixing the polymer and active ingredient may be any known admixture apparatus. The parameters for admixing are dependent upon the chemical structures of the components. In the formation of the active polymer layer, the methods will vary in accordance with the components. For example, when cellulose polymers are used as the water-soluble polymers, the admixed components may be compacted into layers by using known apparatus. If the water-soluble polymers are nature polymers such as gelatin and carrageenan, the admixtures of all the components will be cast into layers.

The blocks of the present invention can be produced by a variety of process, e.g., casting/moulding process, by tablet compression process or by an extrusion process. The casting process which is well within the skill of those in the art involves the melting of the ingredients and then casting the melt into appropriate shaped moulds and allowing the melt to cool and solidify.

In another preferred embodiment of the invention, the detergent mixtures are homogenized and compressed in a screw extruder. The mixtures are extruded through a plate with a slit, resulting in the formation of a film.

After the active polymer layer is formed, one adhesive layer is laminated onto one side of the active polymer layer, and one release layer is disposed onto the adhesive layer to form the tape. Without wishing to be bound by any particular theory or explanation, it is believed that when the water soluble adhesive layer holds the tape onto the cooling coils (for air conditioning systems), the adhesive will be consumed, then condensate water contacts the active polymer layer causing the active ingredients to be released into the condensate water, and then the active polymer layer develops sticky properties allowing the tape to stick to the coil. This process will repeat until the entire active polymer layer is consumed.

The water-erodable adhesive layer comprises an alkyl cellulose or hydroxyalkyl cellulose and a bioadhesive polymer, polyvinyl pyrrolidone, polyethylene glycol, poly vinyl alcohol, and poly vinyl acetate

In one embodiment, the active polymer layer may comprise at least one water soluble adhesive polymer so that the active polymer layer itself can hold onto any applicable surfaces including cooling coils of air conditioning systems. Then, the tape does not need a separate adhesive layer as discussed above. A protection layer is now needed for the entire tape before its application. The methods of manufacturing this kind of tape are similar to the ones described above.

Water soluble adhesive polymers are well known in the arts. As long as the water soluble adhesive polymers are compatible with the desired active ingredients, they can be used. For example, U.S. Pat. No. 5,332,607 discloses that water soluble adhesive polymers contains as essential constituents alkoxyethyl acrylate, styrene sulfonate, and a copolymer of these monomers and other monomers. It is to be appreciated that the present invention is restricted to any particular water soluble adhesive polymers.

The tape may have holes in them to allow air to pass through, thus reducing the instance of air flow blockage

For air conditioning systems, when the water soluble tapes of the present invention are held onto the cooling coils by their adhesive characteristics (from either the adhesive layer or the water soluble adhesive polymers), the active ingredients embedded within the water soluble polymers will be released in a sustained manner when they are exposed to the condensate water formed on the cooling coils when the air conditioning systems are in operation. The released active ingredients will flow with the condensate water to the collecting pan and draining pipelines and at the same time perform the cleaning and disinfecting functions including killing microorganisms, preventing fouling, preventing corrosion, preventing scale deposition, and removal of dust and grime.

While the present invention has been described with reference to particular embodiments, it will be understood that the embodiments are illustrative and that the invention scope is not so limited. Alternative embodiments of the present invention will become apparent to those having ordinary skill in the art to which the present invention pertains. Such alternate embodiments are considered to be encompassed within the spirit and scope of the present invention. Accordingly, the scope of the present invention is described by the appended claims and is supported by the foregoing description.

What is claimed is:

1. A water soluble tape for controlled release of at least one active ingredient, said tape comprising:
a water soluble polymer layer containing at least one water soluble polymer; and at least one active ingredient; whereby all the ingredients of the water soluble layer are thoroughly admixed and formed into the layer; and
a water soluble adhesive layer laminated onto the water soluble polymer layer;
wherein when the water soluble tape is applied via the adhesive layer to a surface of an object where condensate water will be formed, the condensation water will cause the at least one active ingredient to be released in a sustained manner.

2. The water soluble tape of claim 1, wherein the at least one water soluble polymer is in the range of 0.1-99.9% w/w; and wherein the at least one active ingredient is in the range of 0.1-99.9% w/w.

3. The water soluble tape of claim 1, wherein the at least one water soluble polymer is selected from the group consisting of water-soluble poly(meth)acrylates, water-soluble polyamides, water-soluble polyesters, water-soluble polyurethanes, water-soluble poly(vinyl amine), water-soluble poly(ethylene imine), water-soluble amine/epihalohydrin polyamines, water-soluble poly(meth)acrylamide, water-soluble (meth)acrylamide copolymers, water-soluble poly(meth)acrylic acid, water-soluble copolymers of (meth)acrylic acid, poly(diallyl dimethyl ammonium halides), copolymers of diallyl dimethyl ammonium halides, water-soluble vinyl pyrrolidone, water-soluble copolymers of vinyl pyrrolidone, poly(meth)acrylamidopropyltrimethyl ammonium halides, copolymers of (meth)acrylamidopropyltrimethyl ammonium halides, poly(meth)acryloyloxyethyltrimethyl ammonium halides, copolymers of (meth)acryloyloxyethyltrimethyl ammonium halides, poly(meth)acryloyloxyethyltrimethyl ammonium methyl sulfate, copolymers of (meth)acryloyloxyethyltrimethyl ammonium methyl sulfate, xanthan gums, sodium alginates, galactomanans, carageenan, gum arabic, hydroxyethyl cellulose, hydroxypropyl cellulose, diallyl dimethyl ammonium chloride graft copolymers of hydroxyethylcellulose, polymeric quaternary ammonium salts of hydroxyethyl celluloses reacted with a trimethyl ammonium substituted epoxide, polymeric quaternary ammonium salts of hydroxyethyl celluloses reacted with lauryl dimethyl ammonium substituted epoxides, a quaternary ammonium derivative of hydroxypropyl guar and combinations thereof.

4. The water soluble tape of claim 1, wherein the at least one active ingredient is selected from the group consisting of pesticides, insecticides, toxicants, insect growth regulators, plant growth regulators, microbial control agents, bioactive control agents, parasites control reagents, bactericides, viricides, fungicides, algaecides, herbicides, nematicides, amoebicides, acaricides, miticides, predicides, schistisomicides, molluscicides, larvicides, pupicides, ovicides, adulticides, nymphicides, repellents, perfumes, fragrance, surfactants and combinations thereof.

5. The water soluble tape of claim 1, wherein the water soluble polymer layer further optionally comprises a binder; wherein the binder is selected from the group consisting of polyvinyl pyrrolidone, sodium acrylate, sodium polyacrylate, carboxymethylcellulose, sodium carboxyinethylcellulose, corn starch, microcrystalline cellulose, propylene glycol, ethylene glycol, sodium silicate, potassium silicate, methacrylate/acrylate copolymers, sodium lignosulfonate, sodium hydroxypropylcellulose.

6. The water soluble tape of claim 1, wherein the water soluble polymer layer further optionally comprises a die release agent; wherein the die release agent is selected from the group consisting of calcium stearate, magnesium stearate, zinc stearate, stearic acid, propylene glycol, ethylene glycol, polyethylene glycol, polypropylene glycol, polyoxypropylene-polyoxyethyleen block copolymers, microcrystalline cellulose, kaolin, attapulgite, magnesium carbonate, fumed silica, magnesium silicate, calcium silicate, silicones, mono- and dicarboxylic acids and core starch.

7. The water soluble tape of claim 1, wherein the water soluble polymer layer further optionally comprises a compression agent; wherein the compression agent is selected from the group consisting of dicalcium phosphate, lactose, sodium phosphate and calcium sulfate dihydrate.

8. The water soluble tape of claim 1, wherein the water soluble polymer layer further optionally comprises a plasticizer; wherein the plasticizer is selected from the group consisting of glycerine, triethanolamine, ethylene glycol, propylene glycol, diethylene glycol, dipropylene glycol, diethanolamine and methyldiethylamine.

9. The water soluble tape of claim 1, wherein the water soluble polymer layer further optionally comprises a filler.

10. The water soluble tape of claim 1, wherein the water soluble polymer layer further optionally comprises a surfactant.

11. The water soluble tape of claim 1, wherein the adhesive layer is made of water soluble adhesive polymers.

12. The water soluble tape of claim 1, further comprises a release layer disposed onto the adhesive layer; wherein the release layer will be removed before the water soluble tape is applied.

13. The water soluble tape of claim 1, wherein the water soluble polymer layer is comprised of two or more layers laminated together.

14. The water soluble tape of claim 1, wherein the object is cooling coils of air conditioning systems; and wherein when the water soluble tape is held onto the surfaces of the cooling coils, the active ingredients will be released by the condensate water formed on the surfaces of the cooling coils, and the active ingredients released will flow with the condensate water to the collecting pans and draining pipelines and at the same time cleanse and disinfect the cooling coils, collecting pans and draining pipelines.

15. A water soluble adhesive tape for controlled release of at least one active ingredient, said tape comprising:
at least one water soluble adhesive polymer; and
at least one active ingredient;
whereby all the ingredients of the water soluble adhesive tape are thoroughly admixed and formed into the tape;
wherein when the water soluble adhesive tape is applied directly to a surface of an object where condensate water will be formed; and wherein the condensation water will cause the at least one active ingredient to be released in a sustained manner.

16. The water soluble adhesive tape of claim 15, wherein the at least one water soluble adhesive polymer is selected from the group consisting of alkoxyethyl acrylate, styrene sulfonate, and a copolymer of these monomers and other monomers.

17. The water soluble adhesive tape of claim 15, wherein the at least one active ingredient is selected from the group consisting of pesticides, insecticides, toxicants, insect growth regulators, plant growth regulators, microbial control agents, bioactive control agents, parasites control reagents, bactericides, viricides, fungicides, algaecides, herbicides, nematicides, amoebicides, acaricides, miticides, predicides, schistisomicides, molluscicides, larvicides, pupicides, ovicides, adulticides, nymphicides, repellents, perfumes, fragrance, and combinations thereof.

18. A method for manufacturing a water soluble tape for controlled release of at least one active ingredient, wherein the tape comprises a water soluble polymer layer having at least one water-soluble polymer and at least one active ingredient, and an adhesive layer; said method comprising the following steps of:
admixing thoroughly of all the components including the at least one water soluble polymer and the at least one active ingredient so as to form the water soluble polymer layer; and
laminating the adhesive layer onto the water soluble polymer layer to form the water soluble tape.

19. A method for utilizing the water due to moisture condensation upon the surfaces of an object, said method comprising the following operations:
applying a water soluble tape that will adhere to the surfaces of the object, wherein the water soluble tape contains at least one water soluble polymer and at least one active ingredient that is embedded within the at least one water soluble polymer and caused to be released by the condensed water of the cooling coils;
thereby the at least one active ingredient released will cleanse and disinfect the surfaces of the object.

20. The utilizing method of claim 19, wherein the object is the cooling coils of air conditioning systems; and wherein when the active ingredients flow with the condensed water from the cooling coils, to collecting pans, and draining pipelines.

21. The utilizing method of claim 19, wherein the at least one water soluble polymer is selected from the group consisting of water-soluble poly(meth)acrylates, water-soluble polyamides, water-soluble polyesters, water-soluble polyurethanes, water-soluble poly(vinyl amine), water-soluble poly(ethylene imine), water-soluble amine/epihalohydrin polyamines, water-soluble poly(meth)acrylamide, water-soluble (meth)acrylamide copolymers, water-soluble poly(meth)acrylic acid, water-soluble copolymers of (meth)acrylic acid, poly(diallyl dimethyl ammonium halides), copolymers of diallyl dimethyl ammonium halides, water-soluble vinyl pyrrolidone, water-soluble copolymers of vinyl pyrrolidone, poly(meth)acrylamidopropyltrimethyl ammonium halides, copolymers of (meth)acrylamidopropyltrimethyl ammonium halides, poly(meth)acryloyloxyethyltrimethyl ammonium halides, copolymers of (meth)acryloyloxyethyltrimethyl ammonium halides, poly(meth)acryloyloxyethyltrimethyl ammonium methyl sulfate, copolymers of (meth)acryloyloxyethyltrimethyl ammonium methyl sulfate, xanthan gums, sodium alginates, galactomanans, carageenan, gum arabic, hydroxyethyl cellulose, hydroxypropyl cellulose, diallyl dimethyl ammonium chloride graft copolymers of hydroxyethylcellulose, polymeric quaternary ammonium salts of hydroxyethyl celluloses reacted with a trimethyl ammonium substituted epoxide, polymeric quaternary ammonium salts of hydroxyethyl celluloses reacted with lauryl dimethyl ammonium substituted epoxides, a quaternary ammonium derivative of hydroxypropyl guar and combinations thereof.

22. The utilizing method of claim 19, wherein the at least one active ingredient is selected from the group consisting of pesticides, insecticides, toxicants, insect growth regulators, plant growth regulators, microbial control agents, bioactive control agents, parasites control reagents, bactericides, viricides, fungicides, algaecides, herbicides, nematicides, amoebicides, acaricides, miticides, predicides, schistisomicides, molluscicides, larvicides, pupicides, ovicides, adulticides, nymphicides, repellents, perfumes, fragrance, surfactants, anti scale agents, anti corrosion agents and combinations thereof.
